(19) United States
(12) Patent Application Publication
(10) Pub. No.: US 2010/0146012 A1
(43) Pub. Date: Jun. 10, 2010

(54) PREVIEWING SEARCH RESULTS FOR SUGGESTED REFINEMENT TERMS AND VERTICAL SEARCHES

(75) Inventors: Scott Beaudreau, Redmond, WA (US); Jamie Buckley, Redmond, WA (US); Deana R. Fuller, Seattle, WA (US); Mira Lane, Redmond, WA (US); Brian MacDonald, Bellevue, WA (US); Hugh Williams, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/328,570

(22) Filed: Dec. 4, 2008

(51) Int. Cl. G06F 7/10; G06F 17/30; G06F 7/00

(52) U.S. Cl. 707/803; 707/E17.014

(57) ABSTRACT

An embodiment of the current invention is directed to presenting a preview of search results for a suggested search. A search engine query is received. One or more search results are generated. One or more suggested, search terms are generated. A search engine results page is generated, including the one or more search results and the one or more suggested, search terms. An indication is received, indicating that a preview of search results related to a selected, suggested, search term is to be displayed. A preview window including a results section and a menu-bar section is generated. One or more search results related to the selected, suggested, search term are acquired. The one or more search results are presented in the preview window. The preview window allows interaction with the one or more search results.

### INTRODUCTION

Search engines provide an important method of locating information on the Internet. However, often times users are not able to come up with search queries that provide results directly related to their intended search target. Query suggestions are becoming an important source of alternate queries for users when searching for a particular topic. Such query suggestions are often used by users in cases when the users are unsure of what terms would narrow results effectively. In addition to narrowing search results, to gain focus directed to a particular topic, alternate queries can be performed that limit search results to particular types of media or particular types of information. Vertical searches can provide results which only return links to images, videos, or some other type of media or other information.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section below. This summary is not intended to identify key features or essential features of the claimed subject matter, nor is it intended to be used as an aid in isolation to determine the scope of the claimed subject matter.

Embodiments of the present invention are related to presenting a preview of search results for a suggested search provided on a search engine result page. A search engine query is received. One or more search results are generated. One or more suggested-search terms are generated. According to an embodiment, suggested-search terms can refine an original query. According to another embodiment, suggested-search terms can help a user discover related concepts. A search engine results page is generated including the one or more search results and the one or more suggested search terms. An indication is received, indicating that a preview of search results related to a selected, suggested-search term is available and may be displayed. A preview view or window including a results section and a menu-bar section is generated. One or more search results related to the selected, suggested search term are acquired. The one or more search results are presented in the preview window.

### BRIEF DESCRIPTION OF THE DRAWINGS

Illustrative embodiments of the present invention are described in detail below with reference to the attached drawing figures, which are incorporated by reference herein and wherein:

FIG. 1 depicts a block diagram of an exemplary computing environment suitable for implementing an embodiment of the invention;

FIG. 2 depicts a block diagram of an exemplary network environment suitable for implementing an embodiment of the invention;

FIG. 3 depicts a screen display of an exemplary search engine results page, in accordance with an aspect of the present invention;

FIGS. 4A-4C depict screen displays providing a preview of search results with query suggestions on a search engine results page, in accordance with an aspect of the present invention;

FIG. 5 depicts a screen display of an exemplary preview window, in accordance with an aspect of the present invention;

FIG. 6 depicts a screen display illustrating the generation of a preview window, in accordance with an aspect of the present invention;

FIG. 7 is a flow diagram showing a method of presenting search results related to a search-refinement term, in accordance with an aspect of the present invention;

FIG. 8 is a flow diagram showing a method of presenting search results related to a vertical-search category, in accordance with an aspect of the present invention; and

FIG. 9 is a flow diagram showing a method of presenting search results related to a search term, in accordance with an aspect of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to presenting a preview of search results related to a suggested search provided on a search engine results page. Search-engine result pages attempt to provide the user with relevant results with often very limited information. The user's query is often somewhat ambiguous and might represent several distinct concepts. Therefore, in addition to search results for users search queries, search engines may present users with a list of suggested search queries that, if selected, may return results closer to what the user was seeking. Such suggested search queries include refinement suggestions, which are suggestions that are meant to disambiguate initial search query strings. By way of example, a search for the term “American” might produce results relating to people from the US, people from South America, and American Airlines. A list of suggested search refinement terms in this example, might include “American Airlines,” “US American,” and “South American.” Suggested search queries can also include different “verticals.” A vertical search does not change the meaning or content of the search terms, but instead alters what types of results are returned. By way of example, different vertical-search categories include images, videos, news posting, blogs, and products. Other types of suggested search terms might refine the results in terms of location and time, for example.

The use of query suggestions can be important as a source of alternate queries for users when searching for a particular topic. Users often use the suggestions when they are unsure about what words to use in forming a search query, when they are not finding relevant information, and when they are searching within the category space of a particular topic. But query suggestions might not always be obvious to end users. A search results page can include ten or more result items, sponsored results, instant answers, and suggested queries. Users can find it difficult to examine all of the results on the page efficiently. Suggested query refinements can add to the cognitive load for users and can be counterproductive in some cases.

According to an embodiment of the invention, users can easily and nearly instantly preview the results relating to a specific query refinement. A subset of the modified results can be displayed in a concise format within a floating or embedded preview window near the link. If users see results they are looking for, they can click thru to jump from the preview to a full view. According to other embodiments of the present invention, they can also explore and preview the results with more detail within the preview window. By way of example, an image preview of a number of small images could be presented in the preview window that allows the user to zoom into any of the small images from the preview window. Viewing the preview results via different sort and filter options is also possible within the preview window, according to a further embodiment.

Preview windows can have a standardized interface, in accordance with an embodiment of the invention. The preview window can be a window that is floating above the core page, or parent window, with a light border. It can have some common elements like refinements and glyphs to jump thru, view full screen, or “pin” or “dock” the results in the parent window. It can also support different visualization providers for various query types and contexts. Support for previewing Web pages, images, videos, blogs, news, people, products, offers, and more can be provided. These have different visualization requirements, but they can leverage the same common core. A smart layout-management approach can be used to position the preview window near the page element, but without covering it. This means that the preview window can be shown on the right or left of the element, and above or below it as well.

According to an embodiment of the invention, there are a number of ways that the preview window could be activated. The elements in the page that support query refinements could indicate that they support previews through some visual appearance. By way of example, this could be an initial glyph next to the element or the element could be underlined, or in bold-face print. The user could hover over the glyph for some defined time delay to activate the preview window. The hover target might not be visible initially. Instead, the user might first hover over the element in question to reveal the glyph momentarily. The user could then interact with the glyph by hovering over it or by clicking it. This represents a two-step process that provides a higher confidence of user intent. Other mouse interactions could take advantage of various mouse movements such as “wiggle” and “circle.” Those skilled in the art will recognize that there are many ways users could indicate that a preview window is to be displayed. According to other embodiments of the invention, keyboards, pens, touch, and other input devices could be used to indicate a preview window should be displayed.

A user should be able to “pin” or “dock” the preview results from a specific query refinement such that it becomes a new section in the current search results page, in accordance with an embodiment of the invention. This may not change the current query from the user's perspective, but it might add metadata to the query string parameters to track this detail. By way of example, when preview results are pinned, the preview window could remain stationary while the page scrolls down to show the location of the new target section. Once this is visible, the preview window could move with animation in a way that makes it look like it is merging down into the page at the specific location. As another example, the page might not scroll, but the animation might be shown enough for the user to realize it was effectively added to the page, either above or below the user's current view point.

According to a further embodiment of the invention, users could be able to interact with the preview results within the preview window. By way of example, this interaction can include interacting with specific result items to view them in more detail, navigating to the item directly, and refining the search results. Another useful aspect is to “save” the item to the user's local or cloud-based storage. Saving the item stores the metadata for the search result along with the following: query items, category, time, location, content type, and domain. Those skilled in the art will recognize that there are other forms of data that may be stored with the metadata for the search result. Saved results and their collections could be viewed by selecting a “My” search scope in the core search site. They could also be accessed as a “scope refinement” preview of the current query (or no query). This enables users to preview the search results based on searching their stored collections. Those skilled in the art will recognize that additional inline refinements could be used to filter, group, and sort these results further.

According to an embodiment of the invention, a common model for refining the results in the preview window is present. By way of example, the refinements in this preview window could include sorting, filtering, and grouping. They can be extensible and they are implemented by various visualizations as appropriate.

Those skilled in the art will recognize that a number of optimizations could be performed to enhance embodiments of the present invention. By way of example, there is an opportunity to pre-fetch content for the most common query refinements and provide those to the user proactively. According to an embodiment, pre-fetched results could be embedded in the page at render time, or they could be pre-fetched asynchronously after the page has loaded. The decisions on if and when to pre-fetch content can depend on a number of factors, including thresholds of bandwidth, complexity, latency, and refinement confidence.

As another example of an optimization, there might be a need to defer download of some of the previews to improve experienced performance. This applies to some of the scripts and user interface code for the core itself and the various visualizations that might be used. For example, it may not be efficient to download a “Deep Zoom” visualization during the core page load. Such a component might be 1 KB to 20 KB in size, which is heavy for search engines. Therefore, some embodiments may take a deferred approach to downloading assets and take a session-oriented view. Another optimization involves analyzing the query refinement preview patterns for specific users or machines in order to make better decisions about pre-fetching models.

An embodiment of the invention is directed to computer-readable media storing computer-executable instructions for performing a method of presenting a preview of one or more search results. A search engine query is received. One or more search results are generated. One or more suggested, search-refinement terms are generated. A search engine results page is generated, including the one or more search results and the one or more search-refinement terms. An indication is received, indicating that a preview of search results related to a selected, suggested search-refinement term is to be displayed. A preview window including a results section and a menu-bar section is generated. One or more search results related to the selected, suggested search-refinement term are acquired. The one or more search results are presented in the preview window. The preview window allows interaction with the one or more search results.

Another embodiment of the invention is directed to computer-readable media storing computer-executable instructions for performing a method of presenting a preview of one or more search results for a suggested search. A search engine query is received. One or more search results are generated. One or more suggested, vertical-search categories are generated. A search engine results page is generated, including the one or more search results and the one or more vertical-search categories. An indication is received, indicating that a preview of search results related to a selected, suggested vertical-search category is to be displayed. A preview window including a results section and a menu-bar section is generated. One or more search results related to the selected, suggested vertical-search category are acquired. The one or more search results are presented in the preview window. The preview window allows interaction with the one or more search results.

A further embodiment of the invention is directed to computer-readable media storing computer-executable instructions for performing a method of presenting a preview of search results for a suggested search. A search engine query is received. One or more search results are generated. One or more suggested, search terms are generated. A search engine results page is generated, including the one or more search results and the one or more search terms. An indication is received, indicating that a preview of search results related to a selected, suggested search term is to be displayed. A preview window including a results section and a menu-bar section is generated. The menu-bar section includes a save button, a search-refinement input field, an instant-message-share button, an email-share button, and a docking button. One or more search results related to the selected, suggested search term are acquired. The one or more search results are presented in the preview window. The preview window allows interaction with the one or more search results.

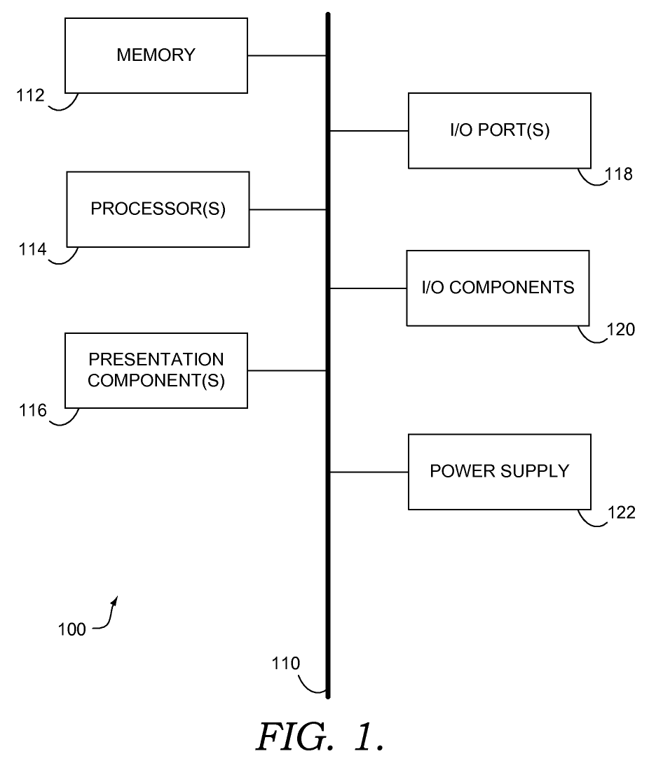

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more external storage components 116, input/output (I/O) ports 118, input components 120, output components 121, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, many processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile memory. Exemplary hardware devices include solid-state memory, such as RAM. External storage 116 includes computer-storage media in the form of non-volatile memory. The memory may be removable, nonremovable, or a combination thereof. Exemplary hardware devices include solid-state memory, hard drives, optical-disc drives, etc. Computing device 100 includes one or more processors that read data from various entities such as memory 112, external storage 116 or input components 120. Output components 121 present data indications to a user or other device. Exemplary output components include a display device, speaker, printing component, vibrating component, etc.

I/O ports 118 allow computing device 100 to be logically coupled to other devices including input components 120 and output components 121, some of which may be built in. Illustrative components include a microphone, joystick, game pad, satellite dish, scanner, printer, wireless device, etc.

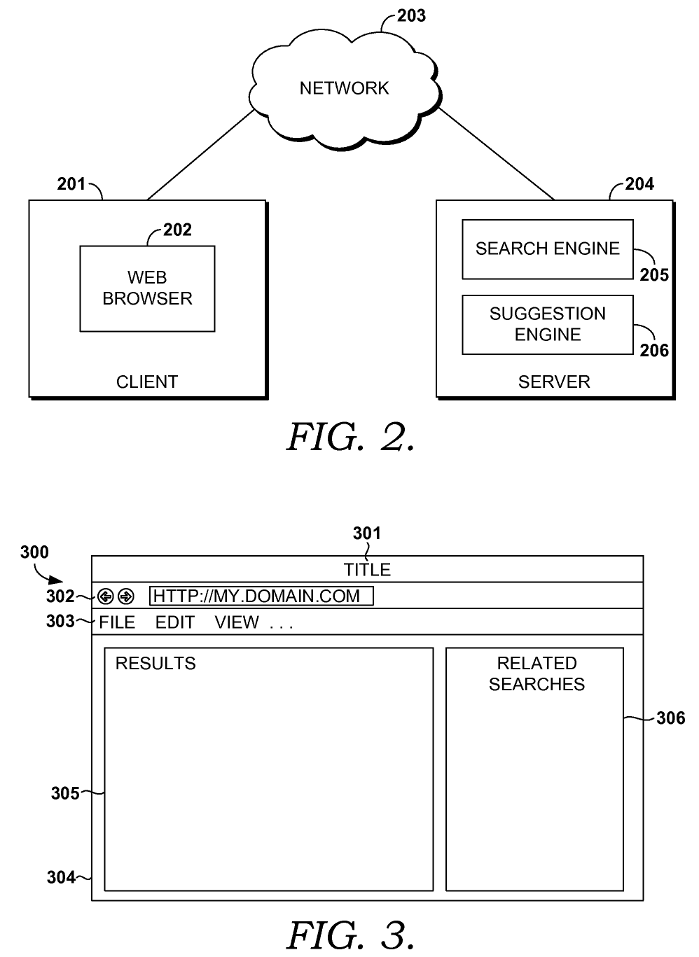

Referring to FIG. 2, a block diagram presenting a network suitable for supporting the current invention is depicted. A client computing device 201 connected to a network 203 is running a web browser application 202. The network 203 could be an intranet or a connection to the Internet. Those skilled in the art will recognize that the web browser application 202 could be any application capable of interacting with a search engine and displaying results. A server 204 is also connected to the network. The server 204 is running a search engine 205 and a suggestion engine 206. The suggestion engine 206 is responsible for providing both vertical-search suggestions and search-refinement suggestions. Search-refinement suggestions are suggestions that aim to remove ambiguity from search terms. Often times users type in search query terms that have a number of different categories of results. By way of example, “Beatles” could produce search results relating to a music group and also an insect. Search-refinement terms aim to narrow the search results in order to more closely match the results the users intend.

In addition to ambiguity in terms, search results also produce links to many different types of media. By way of example, a single search term could produce results with images, videos, and blog entries. Vertical searches aim to narrow the results to a single type, for example, search results that only return images. Those skilled in the art will recognize that the suggestion engine 206 and the search engine 205 could run on separate machines, or on the same machine as the web browsing application 202. The suggestion engine 206 can be used to provide search suggestions, either search-refinement terms or vertical searches, to be presented on a search results page that presents results provided by the search engine 205. According to some embodiments of the invention, when a user hovers over a suggested search on a search engine results page, the search engine 205 running on the server 204 could be queried to provide search results related to that particular search suggestion. According to other embodiments, when a user hovers over a particular search result presented on a search engine results page, the suggestion engine 206 running on the server 204 could be queried to provide search suggestions.

According to an embodiment of the invention, a screen display of a search engine results page 300 suitable for use in executing the present invention is depicted in FIG. 3. The screen display has a title bar 301 for showing a title of the current search engine results page being displayed. An address bar 302 is present to enter web site addresses and give navigational commands. A menu bar 303 may be present to allow the entry of commands via a menu system. The main viewing area 304 of the screen display can be divided into a results-presentation section 305 and a suggested-searches section 306. The specific orientation, layout, and relative sizes of the sections can be altered in many ways in accordance with the current invention. The specific layout presented in FIG. 3 is one example layout. Search results relating to specific search terms entered by a user could be displayed in the results section 305. Additional suggested-search terms, representing either search-refinement terms or vertical searches, or a combination of both can be presented in the suggested-searches section 306. One skilled in the art will recognize that there are many potential layouts for the search results presented in the results section 305 and the suggested search terms presented in the suggested searches section 306.

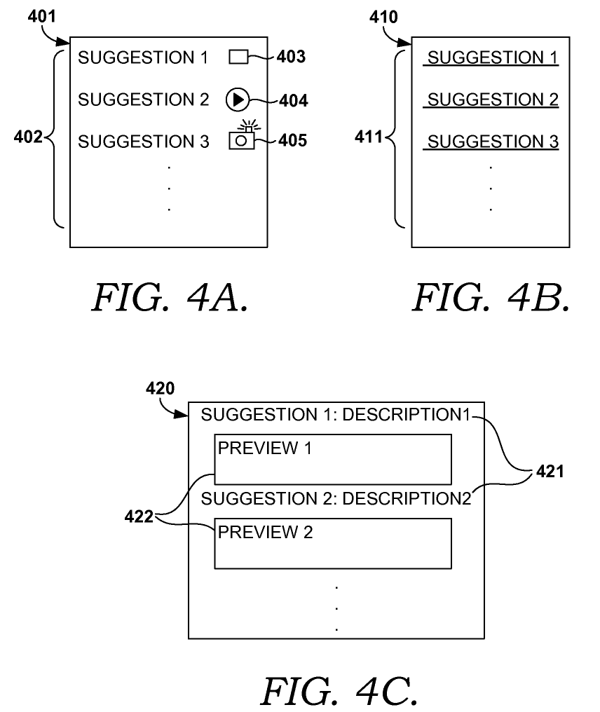

According to an embodiment of the invention, a visual indication that a preview of search results related to suggested-search terms is presented for each of the suggested-search terms in the suggested-searches section 306. FIGS. 4A-4C illustrates several methods of visually indicating previews; however, those skilled in the art will recognize there are other ways of visually indicating the option of previewing search results. Separate icons could be presented next to each of a list of suggested search terms 402. By way of example, a general icon 403 could be used to indicate general web results would be presented in the preview, a play button 404 could be used to indicate videos would be presented in the preview, and a camera icon 405 could be used to indicate images would be presented in the preview, as shown in FIG. 4A. As another example, each of the suggested-search terms could be underlined 411 to indicate previews are available for each term, as shown in FIG. 4B. As a further example, each suggested term could contain a description of the search preview 421, as shown in FIG. 4C. Such descriptions could include image, video, blog, and website. Additionally, a small preview could be presented inline with the search terms 422, providing a further indication of what will be presented in the preview.

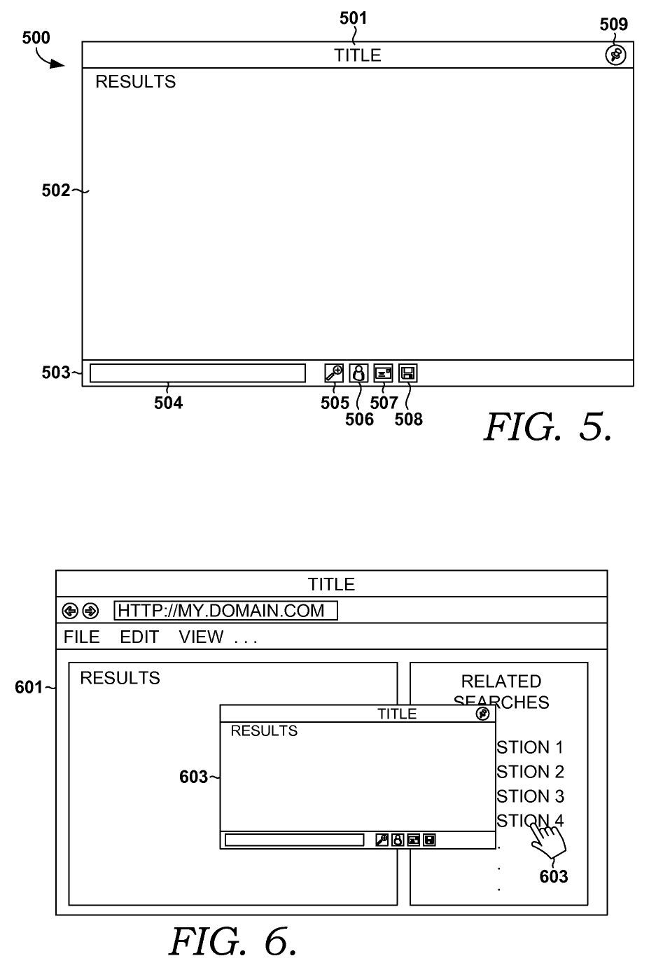

Referring now to FIG. 5, an exemplary preview window that may be displayed to provide search result previews for a query suggestion is depicted. Those skilled in the art will recognize that many combinations and sub-combinations of the features presented with other features could make up a preview window in accordance with an embodiment of the invention. The preview window 500 has a title bar 501 for displaying a title associated with the suggested-search terms that are previewed in the preview window. The preview window 500 has a results section 502 where the results of using the suggested-search terms for a search are presented. The specific layout of the results can be of many different forms, including containing further search-term suggestions. A menu-bar section 503 is presented in the preview window 500 as well. The menu-bar section 503 can contain a number of different input fields and buttons to provide various functionality to the preview window.

According to an embodiment of the invention, the preview window 500 can include an input field for further refining the search 504. By way of example, this input field 504 could be used by the user to input further refining terms to filter the search results. The preview window 500 can include a zoom button 505 that activates a zoom mode allowing the user to zoom into content in the preview window 500. By way of example, if a number of images are being displayed in the results section 502, the zoom mode could be used to zoom into a single images to see it in greater detail without leaving the preview window.

According to another embodiment of the invention, the preview window 500 can include an instant-message-share button 506 to allow users to share the search results being previewed with another user via an instant messaging protocol. The preview window 500 can also include an email-share button to allow users to share the search results being previewed via email. A save button 508 can be included to allow users to save a preview window 500. Those skilled in the art will recognize that saving the search in the preview window can be accomplished in many ways, including saving the search to a server and saving the search locally on the user's computing device. According to an embodiment of the invention, the preview window 500 can also include a docking button 509 to allow the user to dock or “pin” the preview window to the parent window.

There are many ways in which a user could indicate that a preview window should be generated. Additionally, there are many places in which a preview window could be generated. Referring now to FIG. 6, a web browsing application 601 has a suggested-searches section with a number of suggested searches listed. A user can use a number of mouse gestures to indicate that a preview window 603 containing the results from one of the suggested searches should be generated. By way of example, a cursor showing mouse position 602 could be made to hover over a suggestion for a threshold period of time. As another example, the cursor 602 could be made to hover over a query suggestion and then a mouse click could be performed. Once an indication is received that a preview window 603 is to be generated, a location for the preview window 603 is chosen. Those skilled in the art will recognize that there are many algorithms by which the preview window 603 position could be chosen. By way of example, the preview window 603 could be generated to be slightly above the chosen query suggestion.

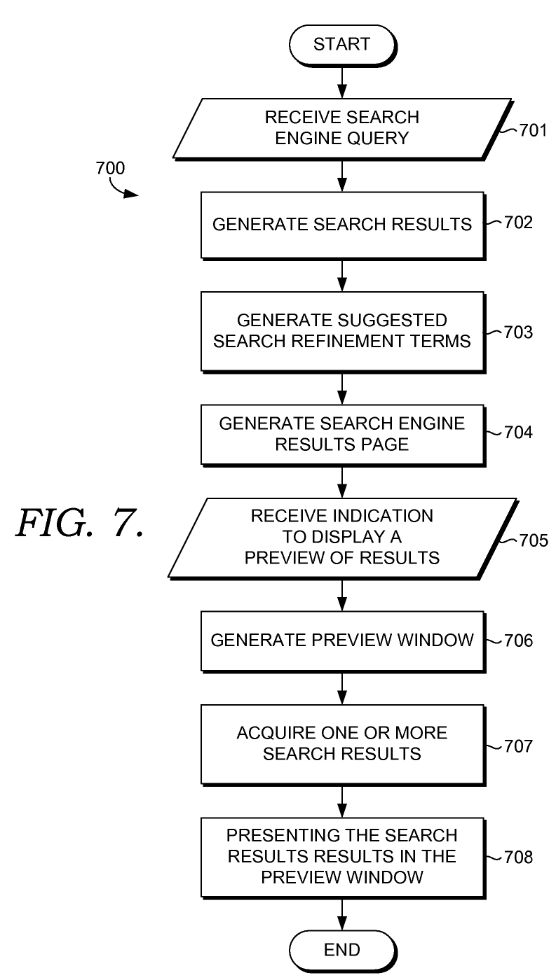

Turning now to FIG. 7, a flow diagram depicting a method 700 of presenting a preview of search results for a suggested search presented on a search engine results page is given. A search query is received, as shown at block 701. Those skilled in the art will recognize that the search query can contain a list of user-enter search query terms. A list of search results is generated, shown at block 702. The search results can be generated by a search engine using a variety of different search algorithms. According to an embodiment, the search results can be returned as a list of website URLs, along with associated names and summaries of text from each website. Those skilled in the art will recognize there are many ways in which the search results could be represented. A list of suggested search-refinement terms is generated, as shown at block 703. Search-refinement terms can be used to disambiguate previous search terms to attempt to narrow the results of a search to pertain to a single topic.

A search engine results page is generated, as shown at block 704. According to an embodiment of the invention, the search engine result page can contain the generated search engine results and the generated suggested search terms. Those skilled in the art will recognize that the search engine results page could be in a number of different formats, similar to the formats discussed with reference to FIG. 3. An indication is received, indicating that a preview of search results related to a selected suggested search-refinement term is to be displayed, as shown at block 705. The indication could be related to a user input with a mouse, such as a hover action. Those skilled in the art will recognize that there are many other mouse gestures and actions that could be used to indicate a preview is to be generated. Additionally, other input devices could be used to generate an indication, including keyboards, touch screens, and trackballs. A preview window is generated, as shown at block 706. The preview window may include a results section and a menu-bar section. The menu-bar section can contain a variety of components, including buttons and input fields that allow variety of functionalities (e.g., saving results, sharing results with other users, and further refining the query).

One or more search results are acquired that relate to the selected, suggested search-refinement term, as shown at block 707. According to an embodiment of the invention, the preview window sends a request to a search engine to obtain the search results. According to another embodiment of the invention, the query results are acquired by the parent window and passed to the preview window. According to a further embodiment of the invention, the query results are pre-fetched, along with results for other suggested search terms. The results are then passed to the preview window.

The search results are presented in the preview window, as shown at block 708. The preview window allows interaction with the results that are presented. By way of example, a user could select a result to be displayed within the preview window. As another example, the user could click-thru, displaying the contents of a search result in the preview window. As a further example, the user could click-thru, displaying the contents of the result in the parent window and closing the preview window. Those skilled in the art will recognize that there are many other forms of interactivity that could be maintained in the preview window, including, playing videos, zooming on images and text, and re-ordering search results.

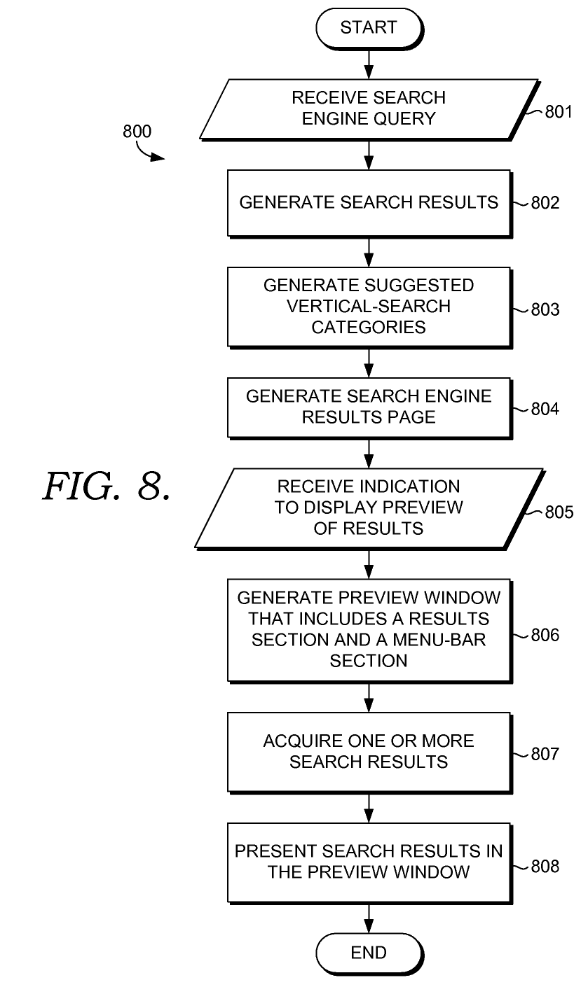

Referring now to FIG. 8, a flow diagram depicting a method 800 of presenting a preview of search results for a suggested search presented on a search engine results page is shown. A search query is received, as shown at block 801, and a list of search results is generated, shown at block 802, similar to blocks 701 and 702 of FIG. 7. The search results can be generated by a search engine using a variety of different search algorithms. According to an embodiment, the search results can be returned as a list of website URLs, along with associated names and summaries of text from each website. Those skilled in the art will recognize there are many ways in which the search results could be represented. A list of suggested, vertical-search category is generated, as shown at block 803. Vertical-search categories narrow the type of result yielded by a primary search. By way of example, vertical-search categories can limit results to images, videos, or blogs. Those skilled in the art will recognize that there are many types of vertical-search categories. A search engine results page is generated, as shown at block 804, similar to block 704 of FIG. 7. An indication is received that indicates a preview of search results related to a selected, suggested vertical-search category is to be displayed, as shown at block 805. The indication can be generated similarly to the indication in block 705 of FIG. 7. A preview window is generated, as shown in block 806, similar to the generation of the preview window in block 706 of FIG. 7. One or more search results are acquired, as shown at block 807, and the search results are presented in the preview window, as shown at block 808, similar to block 707 and block 708 of FIG. 7.

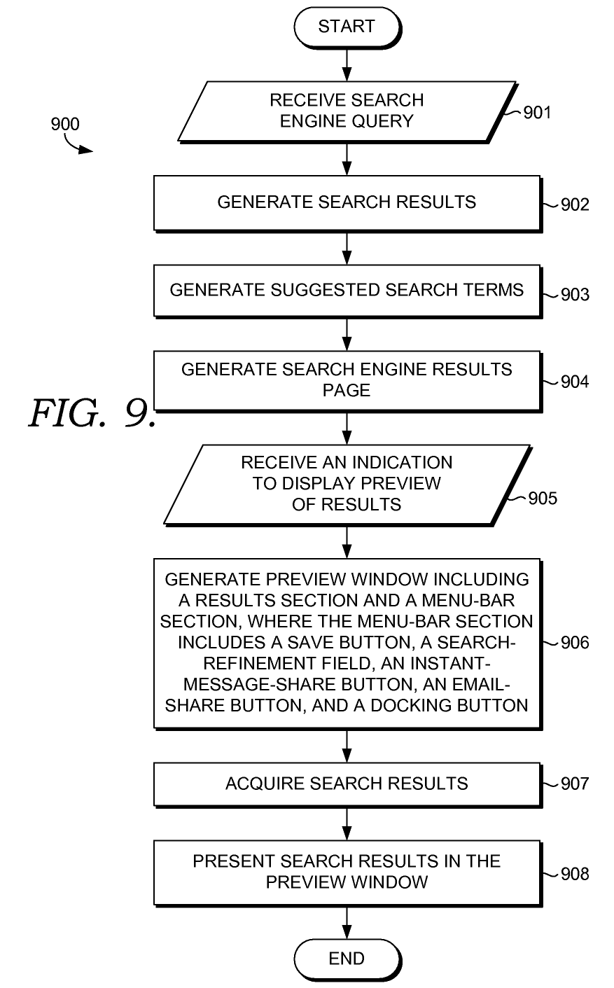

Referring now to FIG. 9, a flow diagram depicting a method 900 of presenting a preview of search results for a suggested search presented on a search engine results page is shown. A search query is received, as shown at block 901, and a list of search results is generated, shown at block 902, similar to blocks 701 and 702 of FIG. 7. A list of suggested search terms is generated, as shown at block 903. Those skilled in the art will recognize that suggested search terms could represent search-refinement terms or could represent vertical-search categories. Vertical-search categories can provide alternate views of results for a query representing different search verticals, related entities, or sponsored results. A search engine results page is generated, as shown at block 904, similar to block 704 of FIG. 7. An indication is received, indicating a preview of search results related to a selected suggested search term is to be displayed, as shown at block 905. Similar to block 705 of FIG. 7, the indication can be generated by a number of user actions. The selected search term is selected from the list of suggested search terms by a user action. By way of example, a user hovering over a suggested search term could both select that search term and indicate that a preview of the search results related to the selected search term are to be displayed in a preview window.

A preview window is generated, including a result section and a menu-bar section, as shown at block 906. The menu-bar section includes a save button, a search-refinement input field, an instant-message-share button, an email-share button, and a docking button. Those skilled in the art will recognize there are a number of possible arrangements of the buttons. One or more search results are acquired, as shown at block 907, and the search results are presented in the preview window, as shown at block 908, similar to block 707 and block 708 of FIG. 7.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media storing computer-executable instructions for performing a method of presenting a preview of one or more search results provided on a search engine results page for a suggested search, the method comprising:
receiving a search-engine query;
generating one or more search results related to the search-engine query;
generating one or more suggested, search-refinement terms;
generating a search engine results page, including the one or more search results and the one or more suggested, search-refinement terms;
receiving an indication, indicating a preview of search results related to a selected, suggested search-refinement term of the one or more suggested, search-refinement terms is to be displayed;
generating a preview window that includes a results section and a menu-bar section;
acquiring one or more search results related to the selected, suggested search-refinement term; and
providing the one or more search results for presentation in the preview window, wherein the preview window allows interaction with the one or more search results.

2. The media of claim 1, wherein the indication is generated by a hover action.

3. The media of claim 1, wherein the menu bar section comprises an input field for indicating a further search refinement is to be performed.

4. The media of claim 1, wherein the menu bar comprises an input field for indicating the search results should be saved.

5. The media of claim 1, wherein the menu bar comprises an input field for indicating the preview window should be docked on a parent window.

6. The media of claim 1, wherein the status bar comprises an input field for sharing the preview window.

7. The media of claim 6, wherein sharing the preview window comprises sharing the preview window via sending an instant message to a user.

8. The media of claim 6, wherein sharing the preview window comprises sharing the preview window via sending an electronic mail message to a user.

9. The media of claim 1, wherein the interaction comprises zooming within the preview window.

10. The media of claim 1, wherein the interaction comprises selecting one of the search results for further inspection within the preview window.

11. The media of claim 10, wherein the selecting comprises clicking on a hyperlink.

12. The media of claim 1, wherein the interaction comprises selecting a search result to be displayed in a parent window.

13. The media of claim 1, wherein the preview window is removed if the preview window is out of focus for a threshold period of time.

14. One or more computer-readable media storing computer-executable instructions for performing a method of presenting a preview of one or more search results for a suggested search provided on a search engine results page, the method comprising:
receiving a search-engine query;
generating one or more search results related to the search-engine query;
generating one or more suggested, vertical-search categories;
generating a search engine results page, including the one or more search results and the one or more suggested, vertical-search categories;
receiving an indication, indicating a preview of search results related to a selected, suggested vertical-search category of the one of the one or more suggested, vertical-search categories is to be displayed;
generating a preview window that includes a results section and a menu-bar section;
acquiring one or more search results related to the selected, suggested vertical-search category; and
providing the one or more search results for presentation in the preview window, wherein the preview window allows interaction with the one or more search results.

15. The media of claim 14, wherein the preview window is generated in-line with a search suggestion.

16. One or more computer-readable media storing computer-executable instructions for performing a method of presenting a preview of one or more search results for a suggested search provided on a search engine results page, the method comprising:
receiving a search-engine query;
generating one or more search results related to the search-engine query;
generating one or more suggested, search terms;
generating a search engine results page, including the one or more search results and the one or more suggested, search terms;
receiving an indication, indicating a preview of search results related to a selected, search term of the one of the one or more suggested, search terms is to be displayed;
generating a preview window that includes a results section and a menu-bar section, wherein the menu-bar section comprises a save button, a search-refinement input field, an instant-message-share button, an email-share button, and a docking button;
acquiring one or more search results related to the selected, suggested search term; and
providing the one or more search results for presentation in the preview window, wherein the preview window allows interaction with the one or more search results.

17. The media of claim 16, wherein the suggested search terms are suggested, search-refinement terms.

18. The media of claim 16, wherein the suggested search terms are suggested, vertical-search categories.

19. The media of claim 16, wherein the one or more search results are pre-fetched.

20. The media of claim 16, wherein the preview window comprises an option for filtering the one or more search results.
